(19) United States
(12) Patent Application Publication
(10) Pub. No.: US 2016/0266771 A1
(43) Pub. Date: Sep. 15, 2016

(54) SYSTEM, METHOD AND COMPUTER PROGRAM PRODUCT FOR FACILITY VISUALIZATION

(71) Applicant: Carrier Corporation, Farmington, CT (US)

(72) Inventors: Caren A. Kittredge, Glastonbury, CT (US); John M. Mandyck, West Hartford, CT (US); Victoria T. Martin, Avon, CT (US)

(21) Appl. No.: 15/065,275

(22) Filed: Mar. 9, 2016

Related U.S. Application Data
(60) Provisional application No. 62/130,940, filed on Mar. 10, 2015.

(51) Int. Cl. G06F 3/0484; G06F 3/0482; G06Q 30/06; G06F 3/0481

(52) U.S. Cl. CPC G06F 3/04842; G06F 3/04815; G06F 3/0482; G06Q 30/0623

(57) ABSTRACT

A method of for visualizing equipment for use in a facility includes presenting a view including at least one facility; upon receiving a selection of a selected facility of the at least one facility, presenting at least one brand of equipment for use with the selected facility; and upon receiving a selection of a selected brand of the at least one brand, presenting information directed to equipment associated with the selected brand.

### CROSS-REFERENCE TO RELATED APPLICATIONS

This application claims the benefit of U.S. provisional patent application Ser. No. 62/130,940, filed Mar. 10, 2015, the entire contents of which are incorporated herein by reference.

### BACKGROUND OF THE INVENTION

The subject matter disclosed herein relates generally to visualization of a facility, and more particularly to visualization of multiple brands of equipment for use in a facility.

Suppliers of equipment offered under a number of brands often have difficulty effectively communicating the various brands and equipment to potential customers. A supplier may have brochures describing equipment offered under each brand, but these can be burdensome to present to a potential customer, and do not present the equipment associated with the brands in a unified manner. A customer may become overwhelmed viewing individual brochures and may not fully understand interactions between the equipment offered under the various brands. Even if the brands and equipment are presented in electronic form, such as a supplier website, there may still be difficulty in the customer understanding synergies achieved by using equipment associated with multiple brands.

### BRIEF DESCRIPTION OF THE INVENTION

According to an aspect of the invention, a method for visualizing equipment for use in a facility includes presenting a view including at least one facility; upon receiving a selection of a selected facility of the at least one facility, presenting at least one brand of equipment for use with the selected facility; and upon receiving a selection of a selected brand of the at least one brand, presenting information directed to equipment associated with the selected brand.

In addition to one or more of the features described above or below, or as an alternative, further embodiments could include wherein presenting the view including the at least one facility includes presenting an aerial view including the at least one facility.

In addition to one or more of the features described above or below, or as an alternative, further embodiments could include wherein upon receiving the selection of the selected facility, presenting a three dimensional view of the selected facility.

In addition to one or more of the features described above or below, or as an alternative, further embodiments could include wherein presenting the three dimensional view of the selected facility includes presenting an interior view of the selected facility overlaid with brand indicators associated with the plurality of brands.

In addition to one or more of the features described above or below, or as an alternative, further embodiments could include wherein upon receiving the selection of the selected brand, presenting at least one equipment associated with the selected brand.

In addition to one or more of the features described above or below, or as an alternative, further embodiments could include wherein upon receiving a selection of a selected equipment of the at least one equipment associated with the selected brand, presenting a view of the selected equipment within the selected facility.

In addition to one or more of the features described above or below, or as an alternative, further embodiments could include wherein presenting the view of the selected equipment within the selected facility includes providing a three-dimensional rendition of traveling along locations of the selected equipment within the selected facility.

In addition to one or more of the features described above or below, or as an alternative, further embodiments could include wherein presenting the view of the selected equipment within the selected facility includes presenting an engineering drawing of the selected equipment.

In addition to one or more of the features described above or below, or as an alternative, further embodiments could include wherein upon receiving the selection of the selected equipment of the at least one equipment associated with the selected brand, presenting at least one feature associated with the selected equipment.

In addition to one or more of the features described above or below, or as an alternative, further embodiments could include wherein presenting at least one feature associated with the selected equipment includes presenting a feature indicator associated with each feature associated with the selected equipment.

In addition to one or more of the features described above or below, or as an alternative, further embodiments could include providing an interactivity menu identifying at least two brands; and upon receiving a selection of a first brand, presenting a group of brands, including the first brand, the group of brands associated with equipment that interacts.

In addition to one or more of the features described above or below, or as an alternative, further embodiments could include upon receiving a selection of one brand of the group of brands, presenting interactivity of the equipment associated with each brand of the group of brands.

In addition to one or more of the features described above or below, or as an alternative, further embodiments could include wherein the at least one brand comprises a plurality of brands.

According to another aspect of the invention, a system for visualizing equipment for use in a facility includes a processor; and a memory comprising computer-executable instructions that, when executed by the processor, cause the processor to perform operations, the operations comprising: presenting a view including at least one facility; upon receiving a selection of a selected facility of the at least one facility, presenting at least one brand of equipment for use with the selected facility; and upon receiving a selection of a selected brand of the at least one brand, presenting information directed to equipment associated with the selected brand.

According to another aspect of the invention, a computer program product, tangibly embodied on a computer readable medium, for visualizing equipment for use in a facility, the computer program product including instructions that, when executed by a processor, cause the processor to perform operations including presenting a view including at least one facility; upon receiving a selection of a selected facility of the at least one facility, presenting at least one brand of equipment for use with the selected facility; and upon receiving a selection of a selected brand of the at least one brand, presenting information directed to equipment associated with the selected brand.

Embodiments provide a technical effect of effectively visualizing a variety of equipment associated with a number of brands. Embodiments also provide for visualization of interactions between equipment offered under different brands.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a flowchart of a process for presenting brands of equipment for use with a facility in an exemplary embodiment;

FIG. 2 is a flowchart of a process for presenting information on features of equipment for use with a facility in an exemplary embodiment;

FIG. 3 is a flowchart of a process for presenting interactivity between brands of equipment in an exemplary embodiment;

FIG. 4 depicts a user interface for selecting a facility in an exemplary embodiment;

FIG. 5 depicts a user interface for presenting a selected facility in an exemplary embodiment;

FIG. 6 depicts a user interface for presenting brands of equipment for use with a selected facility in an exemplary embodiment;

FIG. 7 depicts a user interface for presenting equipment associated with a selected brand in an exemplary embodiment;

FIG. 8 depicts a user interface for presenting a view of selected equipment in an exemplary embodiment;

FIG. 9 depicts a user interface for presenting features associated with selected equipment in an exemplary embodiment;

FIG. 10 depicts a user interface for presenting interactivity among a group of brands in an exemplary embodiment;

FIG. 11 depicts a user interface for presenting interactivity among equipment associated with the group of brands in an exemplary embodiment;

FIG. 12 depicts a user interface for presenting interactivity among equipment associated with the group of brands in an exemplary embodiment; and

FIG. 13 depicts a system for providing facility visualization in an exemplary embodiment.

### DETAILED DESCRIPTION OF THE INVENTION

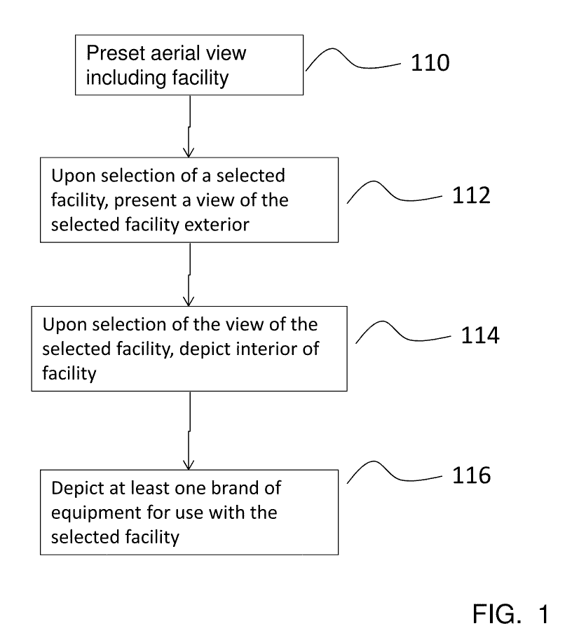

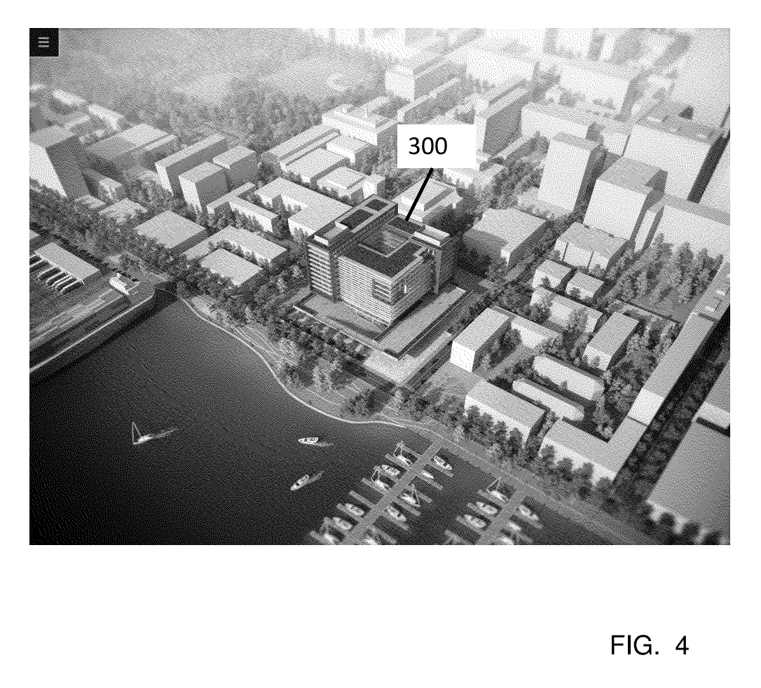

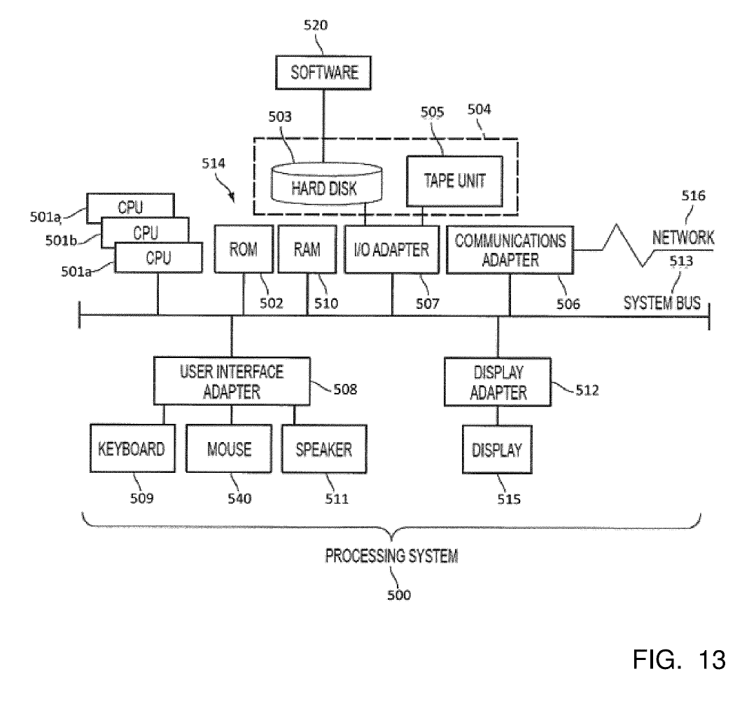

Embodiments of the invention described herein relate to methods, systems and computer program products for providing visualization of brands of equipment for use with a facility. Embodiments allow users to visualize brands of equipment for use in a facility, features of the equipment associated with each brand and interactivity between equipment in a group of brands. FIGS. 1-3 depict exemplary processes executed in embodiments of the inventions. FIGS. 4-12 depict exemplary user interfaces in embodiments of the inventions. FIG. 13 depicts a system for executing the processes and providing the user interfaces in an exemplary embodiment.

FIG. 1 is a flowchart of a process for presenting brands of equipment for use with a facility in an exemplary embodiment. The process begins at 110, by presenting a user interface including a 3D aerial view of one or more facilities. FIG. 4 depicts a user interface presenting a facility 300 available for selection. Facility 300 is identified as being available for selection by virtue of facility 300 including surface ornamentation. Other facilities in the aerial view not available for selection have no surface ornamentation and cannot be selected. It is understood that more than one facility may be identified as available for selection, and a single facility 300 is shown as an example. Other techniques may be used to distinguish facilities for selection, such as icons, color schemes, etc. The term facility is intended to have a broad meaning and may include a wide variety of locations that house equipment associated with one or more brands. Facilities include, but are not limited to, commercial buildings (e.g., hotels), industrial buildings, residential buildings, governmental buildings, university buildings, hospitals, parking garages, ports, airports, trains, plane, ships (recreational and commercial), etc.

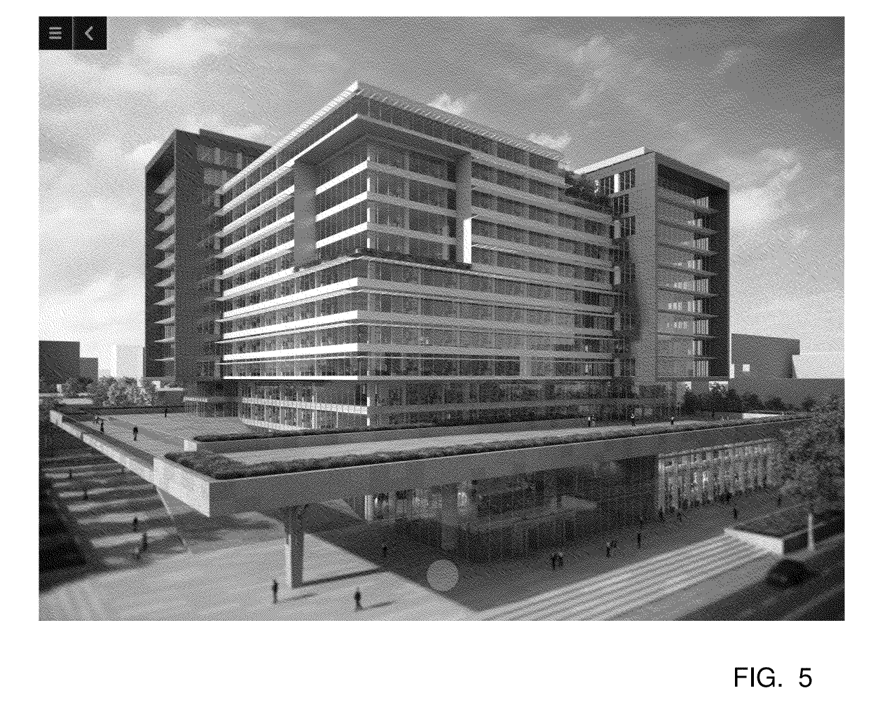

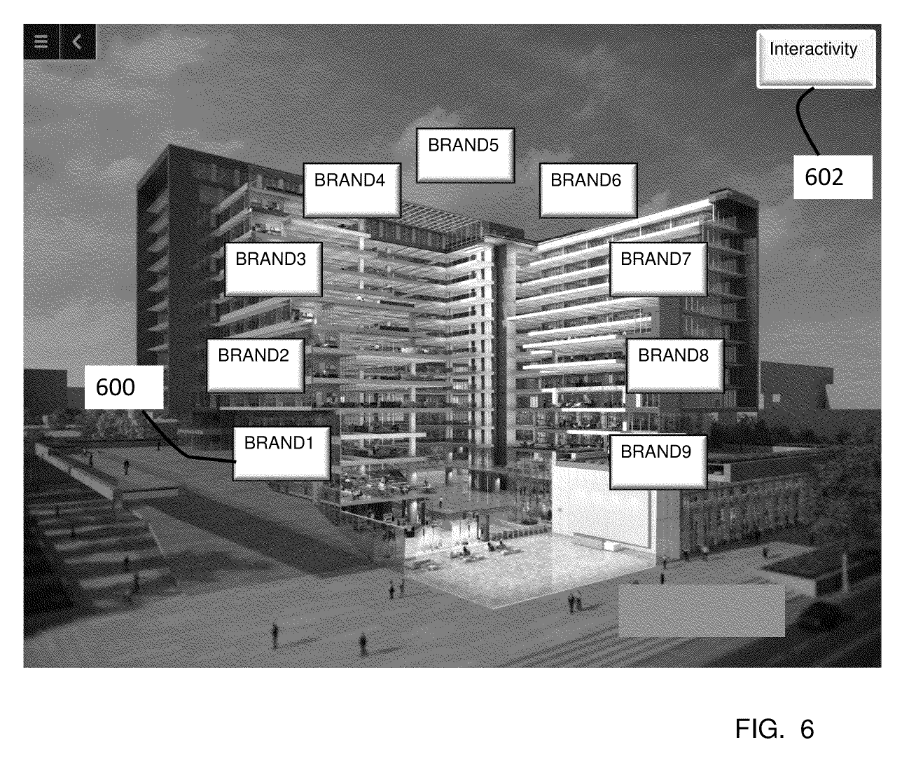

Referring to FIG. 1, at 112 a user selects a facility as a selected facility and the system presents a 3D view of the exterior of the selected facility. Selection may be made using known input devices, as described in further detail herein with reference to FIG. 13. FIG. 5 depicts a user interface for presenting a 3D view of a selected facility in an exemplary embodiment. If the user is interested in viewing brands of equipment for use with the selected facility, the use may select the exterior view of facility. Once the exterior view of the facility is selected, a 3D interior view of the facility is presented, as indicated as 114 of FIG. 1. The interior view may be presented by removing outer layers, or the façade, of the selected facility. The process of FIG. 1 then flows to 116, where at least one brand of equipment for use with the selected facility are presented. FIG. 6 depicts a user interface for presenting a plurality of brands of equipment for use with a selected facility in an exemplary embodiment.

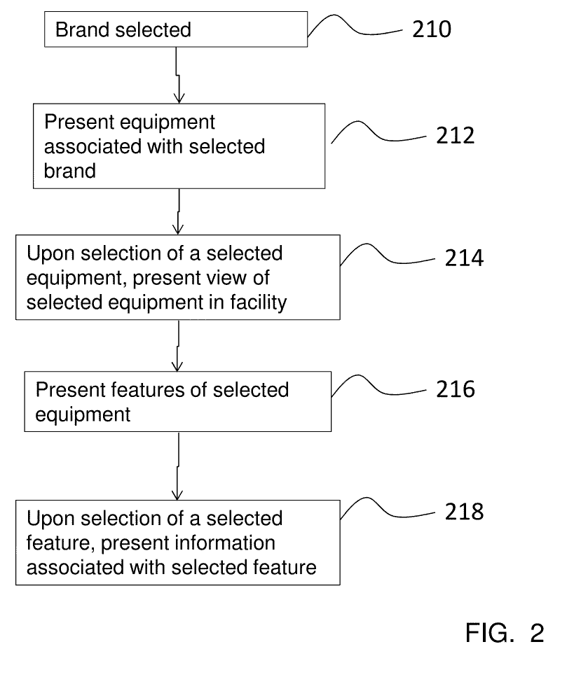

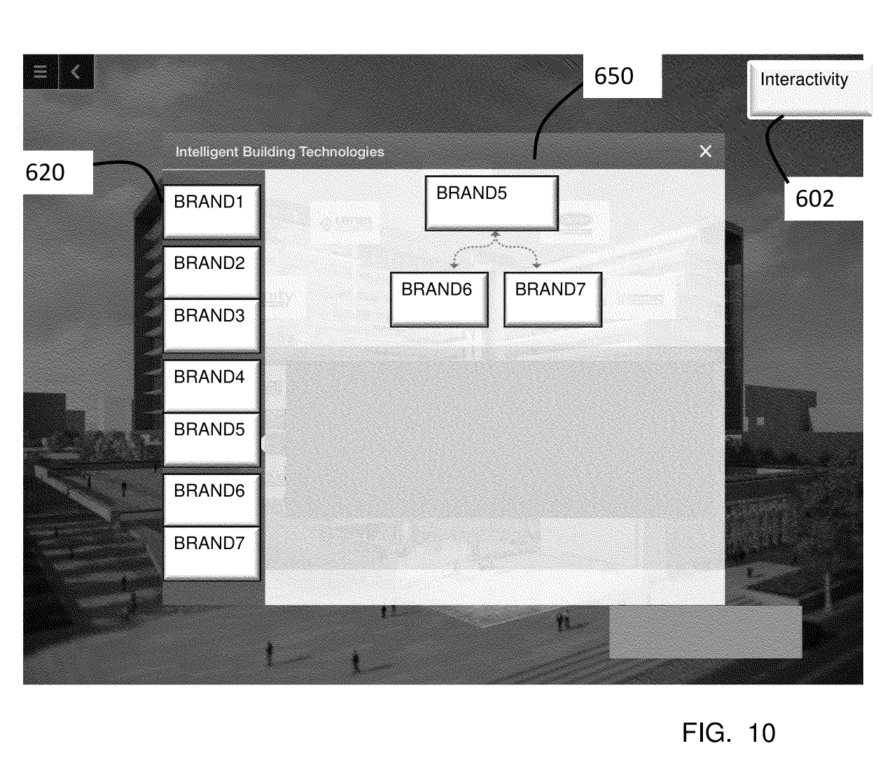

As shown in FIG. 6, a number a brand indicators 600 are overlaid on the 3D depiction of the interior of the selected facility. An interactivity icon 602 is also depicted, and will be described herein with reference to FIGS. 10-12. From the user interface in FIG. 6, a user can select a brand by choosing one of the brand indicators 600. Selecting a brand indicator 600 allows a user to obtain information about equipment for use with the selected facility associated with the selected brand. FIG. 2 is a flowchart of a process for presenting information on features of equipment for use with a facility in an exemplary embodiment.

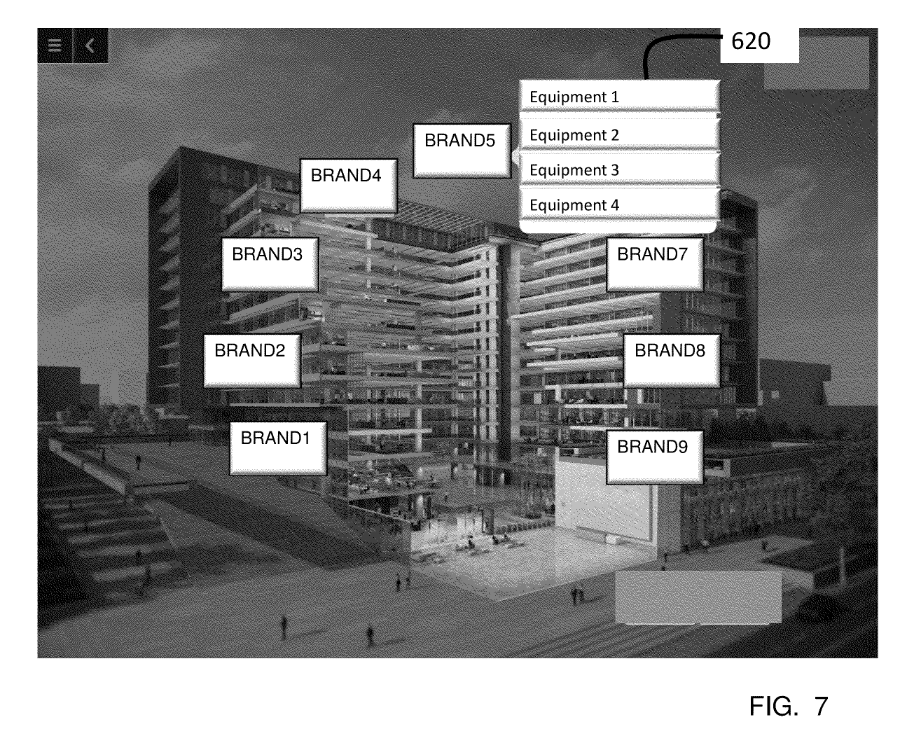

Referring to FIG. 2, the process begins at 210 with selection of a brand indicator 600 to identify a selected brand. Once a selected brand is identified, flow proceeds to 212 where equipment associated with the selected brand and for use with the selected facility is presented. FIG. 7 depicts a user interface for presenting equipment associated with a selected brand in an exemplary embodiment. In FIG. 7, the selected brand is BRAND5 and a list of equipment associated with BRAND5 and for use with the selected facility is presented as shown at 620. It is understood that the available equipment may be shown in other formats, and the list 620 is just one example format.

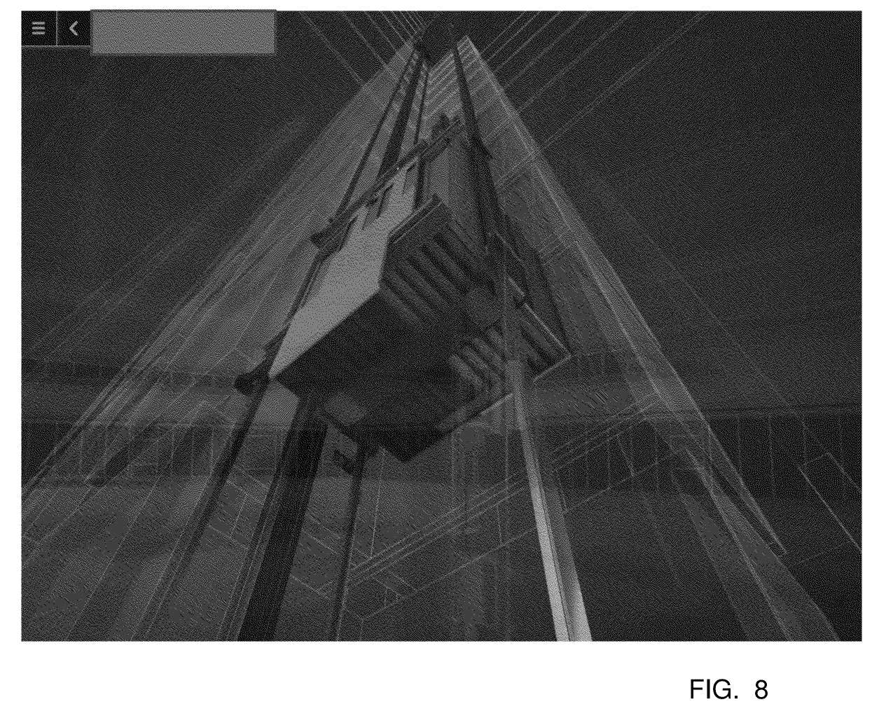

Referring to FIG. 2, at 214 once a user selects a selected equipment from the equipment associated with the selected brand, the process presents a view of the selected equipment in the facility. Presenting a view of the selected equipment in the facility may include traversing the facility in a 3D view to travel along and among components of the selected equipment. FIG. 8 depicts an exemplary user interface to present views of elevator equipment in the facility. The interface of FIG. 8 may present the user with the experience of traveling up an elevator shaft, through an elevator car, and to an elevator equipment area. The visual experience may include a 3D view of one traveling past equipment, through equipment, zooming in and out with respect to the equipment, etc. Presenting a view of the equipment in the facility may use existing engineering drawings to depict the equipment and portions of the selected facility. Other user interfaces may be used to immersively depict locations and components of the selected equipment in the selected facility. For example, an HVAC system may be visualized by traversing the flow path of air though various parts of the facility and HVAC equipment. Block 214 of FIG. 2 allows the user to obtain a physical and spatial indication of the selected equipment within the facility.

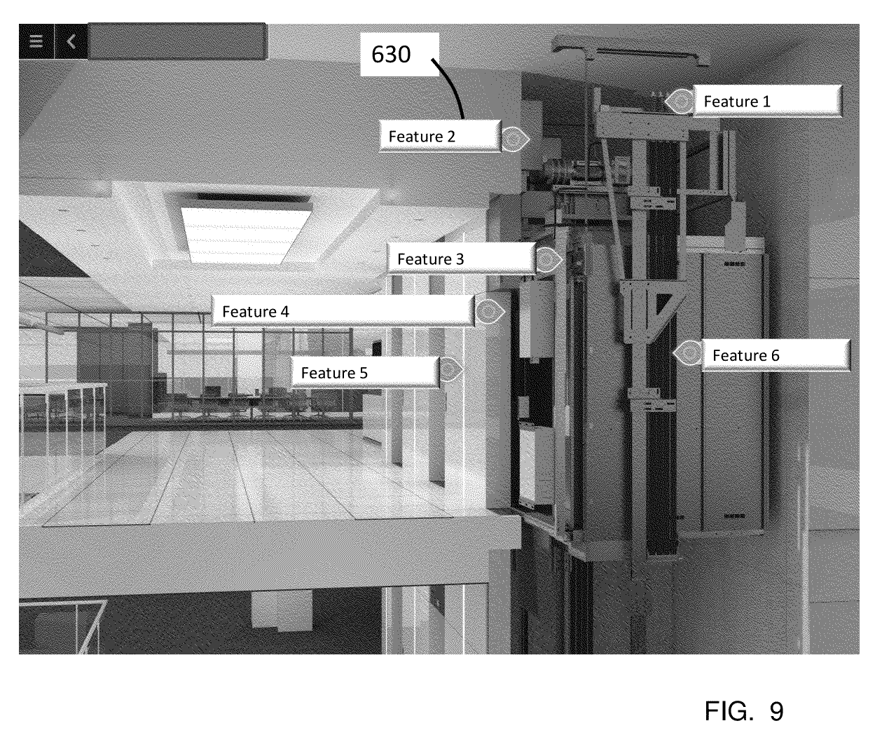

Once the view of the selected equipment is presented at 214, flow proceeds to 216 where features of the selected equipment are presented. FIG. 9 depicts a user interface for presenting features associated with selected equipment in an exemplary embodiment. As shown in FIG. 9, the user interface provides one or more feature indicators 630. Selection of a feature indicator 630 provides information associated with the selected feature as shown at 218 of FIG. 2. In this manner, the user can obtain information about the features of the selected equipment associated with the selected brand.

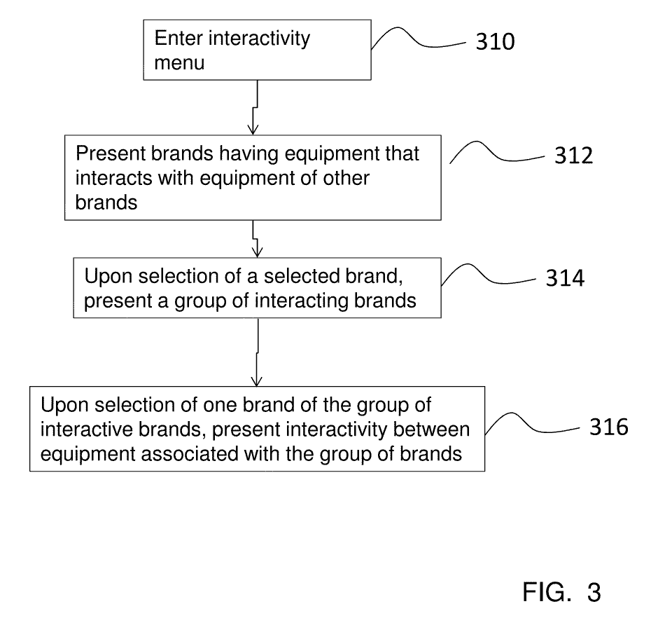

Embodiments also include the ability to provide interactivity information between equipment associated with a group (i.e., two or more) of brands. FIG. 3 is a flowchart of a process for presenting interactivity between brands of equipment in an exemplary embodiment. The process beings at 310 when a user accesses an interactivity menu. This may occur upon selection of an interactivity icon 602, such as that shown in FIG. 6. Once the interactivity menu is accessed, flow proceeds to 312 where the user interface presents brands associated with equipment that interacts with equipment associated with other brands.

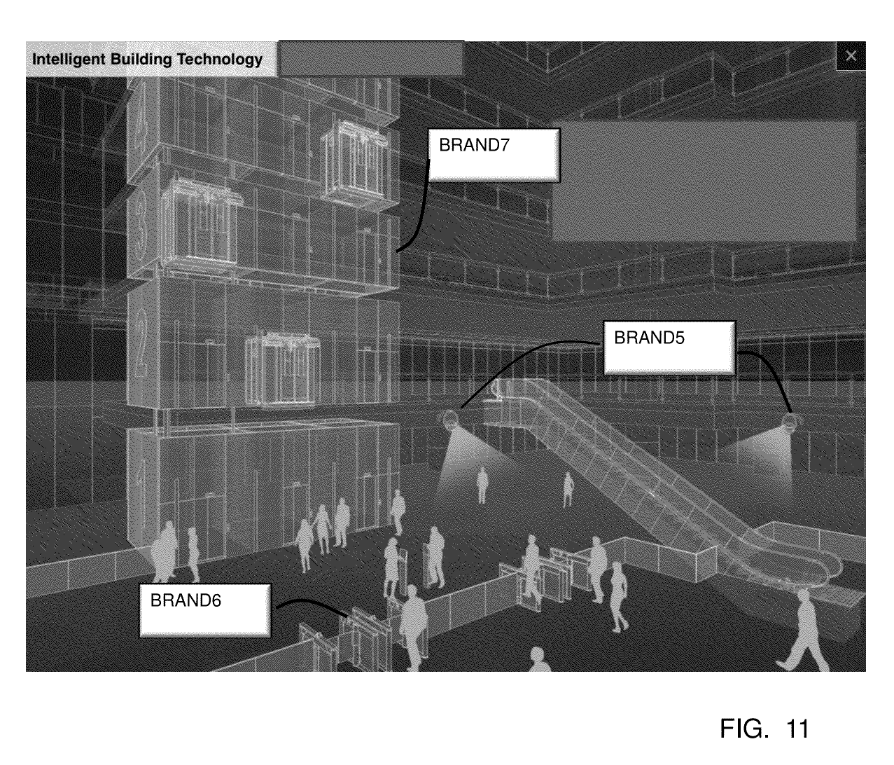

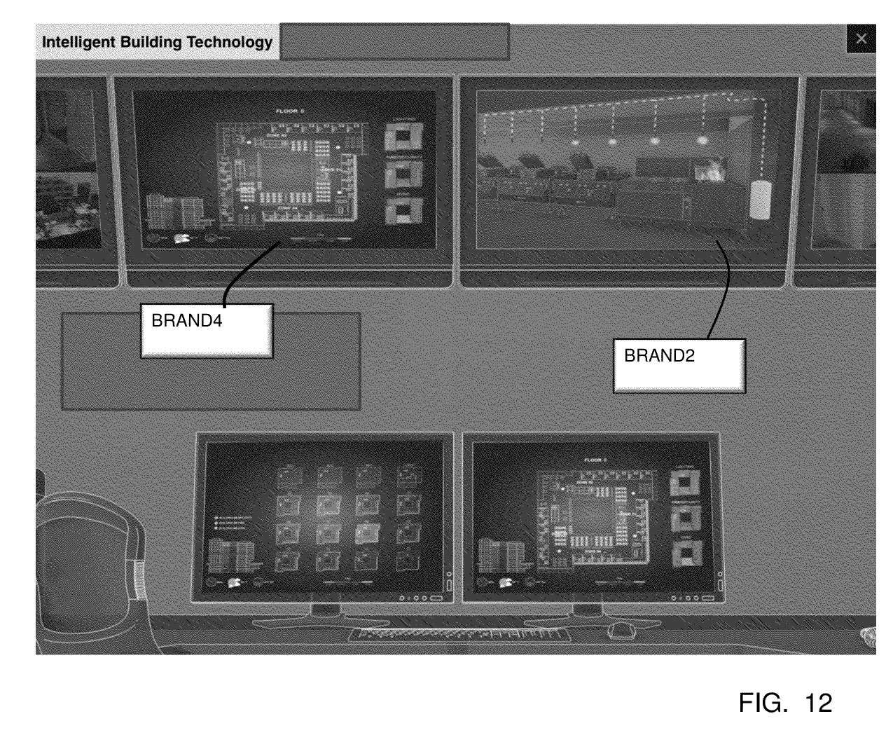

FIG. 10 depicts a user interface for presenting interactivity among a group of brands in an exemplary embodiment. Brand indicators 620 are presented for brands associated with equipment that interacts with equipment associated with other brands. At step 314 of FIG. 3, a user selects a brand indicator 620 to obtain a group of interacting brands. For example, in FIG. 10 the user has selected BRAND5, and presented with a group of interacting brands 650, including BRAND5, BRAND6 and BRAND7. Once the user selects one brand of the group of interacting brands 650, the user interface presents interactivity between equipment associated with the group of interacting brands. This is shown at 316 of FIG. 3. FIG. 11 presents an exemplary user interface generated at 316 of FIG. 3. In FIG. 11, cameras associated with a BRAND5, a building access system associated with BRAND6 and an elevator dispatch system associated with BRAND7 all interact to determine crowd size in a lobby and assign elevator cars accordingly. FIG. 12 presents another exemplary user interface generated at 316 of FIG. 3. In FIG. 12, a firm alarm system associated with BRAND4 and security cameras associated with BRAND2 interact to provide not only a notice of a fire occurrence but also a video stream of the location of the fire. Presenting interactivity information allows a user to easily visualize how equipment associated with different brands can operate in an interacting manner

A system to provide facility visualization may be implemented on a variety of microprocessor based devices, such as a tablet, smartphone, personal computer, etc. Further, the system to provide facility visualization may be hosted at remote location (e.g., a server) and accessed by remote devices (e.g., clients) over a network (e.g., a LAN, WAN, etc.). FIG. 13 depicts a system 500 for providing facility visualization in an exemplary embodiment

Referring now to FIG. 13, there is shown an embodiment of a processing system 500 for implementing the teachings herein. In this embodiment, the processing system 500 has one or more central processing units (processors) 501a, 501b, 501c, etc. (collectively or generically referred to as processor(s) 501). Processors 501, also referred to as processing circuits, are coupled to system memory 514 and various other components via a system bus 513. Read only memory (ROM) 502 is coupled to system bus 513 and may include a basic input/output system (BIOS), which controls certain basic functions of the processing system 500. The system memory 514 can include ROM 502 and random access memory (RAM) 510, which is read-write memory coupled to system bus 513 for use by processors 501.

FIG. 13 further depicts an input/output (I/O) adapter 507 and a network adapter 506 coupled to the system bus 513. I/O adapter 507 may be a small computer system interface (SCSI) adapter that communicates with a hard disk 503 and/or tape storage drive 505 or any other similar component. I/O adapter 507, hard disk 503, and tape storage drive 505 are collectively referred to herein as mass storage 504. Software 520 for execution on processing system 500 may be stored in mass storage 504. The mass storage 504 is an example of a tangible storage medium readable by the processors 501, where the software 520 is stored as instructions for execution by the processors 501 to perform a method, such as the process flows shown in FIGS. 1-3. Network adapter 506 interconnects system bus 513 with an outside network 516 enabling processing system 500 to communicate with other such systems. A screen (e.g., a display monitor) 515 is connected to system bus 513 by display adapter 512, which may include a graphics controller to improve the performance of graphics intensive applications and a video controller. In one embodiment, adapters 507, 506, and 512 may be connected to one or more I/O buses that are connected to system bus 513 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 513 via user interface adapter 508 and display adapter 512. A keyboard 509, mouse 540, and speaker 511 can be interconnected to system bus 513 via user interface adapter 508, which may include, for example, a Super I/O chip integrating multiple device adapters into a single integrated circuit.

Thus, as configured in FIG. 5, processing system 500 includes processing capability in the form of processors 501, and, storage capability including system memory 514 and mass storage 504, input means such as keyboard 509 and mouse 540, and output capability including speaker 511 and display 515. If the device is a tablet or fitted with a touchscreen, the display 515, keyboard 509 and mouse 540 functions may be all implemented by a touch-sensitive display. In one embodiment, a portion of system memory 514 and mass storage 504 collectively store an operating system to coordinate the functions of the various components shown in FIG. 13.

As described above, the exemplary embodiments can be in the form of processor-implemented processes and devices for practicing those processes, such as processors 501. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

1. A method for visualizing equipment for use in a facility, the method comprising:
presenting a view including at least one facility;
upon receiving a selection of a selected facility of the at least one facility, presenting at least one brand of equipment for use with the selected facility; and
upon receiving a selection of a selected brand of the at least one brand, presenting information directed to equipment associated with the selected brand.

2. The method of claim 1, wherein:
presenting the view including the at least one facility includes presenting an aerial view including the at least one facility.

3. The method of claim 1, wherein:
upon receiving the selection of the selected facility, presenting a three dimensional view of the selected facility.

4. The method of claim 3, wherein:
presenting the three dimensional view of the selected facility includes presenting an interior view of the selected facility overlaid with brand indicators associated with the plurality of brands.

5. The method of claim 1, wherein:
upon receiving the selection of the selected brand, presenting at least one equipment associated with the selected brand.

6. The method of claim 5, wherein:
upon receiving a selection of a selected equipment of the at least one equipment associated with the selected brand, presenting a view of the selected equipment within the selected facility.

7. The method of claim 6, wherein:
presenting the view of the selected equipment within the selected facility includes providing a three-dimensional rendition of traveling along locations of the selected equipment within the selected facility.

8. The method of claim 6, wherein:
presenting the view of the selected equipment within the selected facility includes presenting an engineering drawing of the selected equipment.

9. The method of claim 6, wherein:
upon receiving the selection of the selected equipment of the at least one equipment associated with the selected brand, presenting at least one feature associated with the selected equipment.

10. The method of claim 9, wherein:
presenting at least one feature associated with the selected equipment includes presenting a feature indicator associated with each feature associated with the selected equipment.

11. The method of claim 1, further comprising:
providing an interactivity menu identifying at least two brands; and
upon receiving a selection of a first brand, presenting a group of brands, including the first brand, the group of brands associated with equipment that interacts.

12. The method of claim 11, further comprising:
upon receiving a selection of one brand of the group of brands, presenting interactivity of the equipment associated with each brand of the group of brands.

13. The method of claim 1 wherein:
the at least one brand comprises a plurality of brands.

14. A system for visualizing equipment for use in a facility, the system comprising:
a processor; and
a memory comprising computer-executable instructions that, when executed by the processor, cause the processor to perform operations, the operations comprising:
presenting a view including at least one facility;
upon receiving a selection of a selected facility of the at least one facility, presenting at least one brand of equipment for use with the selected facility; and
upon receiving a selection of a selected brand of the at least one brand, presenting information directed to equipment associated with the selected brand.

15. A computer program product, tangibly embodied on a computer readable medium, for visualizing equipment for use in a facility, the computer program product including instructions that, when executed by a processor, cause the processor to perform operations comprising:
presenting a view including at least one facility;
upon receiving a selection of a selected facility of the at least one facility, presenting at least one brand of equipment for use with the selected facility; and
upon receiving a selection of a selected brand of the at least one brand, presenting information directed to equipment associated with the selected brand.
